(19) United States
(12) Patent Application Publication
(10) Pub. No.: US 2003/0101349 A1
(43) Pub. Date: May 29, 2003

(54) Method of using cryptography with biometric verification on security authentication

(76) Inventor: Po-Tong Wang, Taipei City (TW)

Correspondence Address: Po-Tong Wang, PO Box 82-144, TAIPEI, TW

(21) Appl. No.: 09/991,676

(22) Filed: Nov. 26, 2001

(51) Int. Cl. H04K 1/00

(52) U.S. Cl. 713/186; 380/277

(57) ABSTRACT

This invention represents a method of using cryptography with biometric verification on security authentication. The present invention relates to secure transmission of data or confidential information and, in particular, to cryptography technology that prevents the multiple passwords of keys lengthy, inconvenient and hard to be remembered or hidden. The method is used to perform security authentication by utilizing live biometric feature, which is non-transferable and unique among all humans, and operating the asymmetric key of cryptography technique for collation. Therefore, in the present invention, the method is capable of providing cryptography technology in conjunction with the biometric authorization to prevent that people don't like to carry private keys and using a single key only to perform authentication will reveal privacy or private information.

### BACKGROUND OF THE INVENTION

The cryptography techniques exist today including a plurality of encryption/decryption algorithms, cryptanalysis, authentication, digital signature, crypt key management and so on. Its intended purpose is to provide a solution of securely information transmission, exchange and storage. Additionally, based on the foregoing, it would be desirable to achieve the security and privacy of confidential information when it is transmitted or interacted. The method of using the lengthy private key reveals the following two problems.

(1) It is difficult to remember and store securely.

(2) It is easy to be broke and attacked by hackers.

Generally, there are three basic types of crypt keys.

(1) The private (or secret) key is a symmetric technique, which uses the same key for encryption and decryption. However, use of the same key during the encryption and decryption processes make the cipher easy to break and cannot ensure the security of transmission. The private key mechanism is preferably generated using a symmetric algorithm such as DES (D)ata Encryption Standard) and IDEA (International Data Encryption Algorithm).

(2) The public key is an asymmetric encryption technique, which uses two different keys of a pair for encryption and decryption. Therefore, using two asymmetric keys for encrypting and decrypting information makes the cipher more difficult to break. The public key mechanism is known as the RSA (Revest, Shamir and Adleman).

(3) Combing private and public key is a combination of keys that the public key is used for encryption with the random number combination and then the private key is used for the encryption/decryption processes with key transportation. The public/private key system, which is practical, can provide the security of information.

As seen in FIG. 1, generally using cryptography to transmit the confidential information, the sender operates an encryption function (EK) to convert the plain text (M) to cipher text (C). After the cipher text is then transmitted, the recipient performs the reverse process by using a decryption key to recover the plain text, referred to herein as the original text, from the received cipher text. Therefore, the cryptographic transformation is performed by the private key mechanism and public key mechanism for protecting the security information and preventing the unauthorized user to alter the data.

### SUMMARY OF THE INVENTION

The present invention provides a method of using cryptography with biometric verification on security authentication. It is therefore an object of the present invention to perform security authentication by utilizing live biometric feature, which is non-transferable and unique among all humans, and operating the asymmetric key of cryptography technique for collation. It is a further object of the present invention to perform cryptography technology for ensuring secure transmission of data and preventing the multiple keys lengthy, inconvenient and hard to be remembered. Therefore, the method is capable of providing cryptography technology in conjunction with the biometric authorization to prevent that people don't like to carry private keys and using a single key only to perform authentication will reveal privacy. Also, the present invention can be utilized in the application of security techniques for the transmission of data such as the personal authentication for business transactions, economic activities and so on.

### BRIEF DESCRIPTION OF THE DRAWINGS

FIG. 1 is a flow chart to illustrate the transmission process via cryptography.

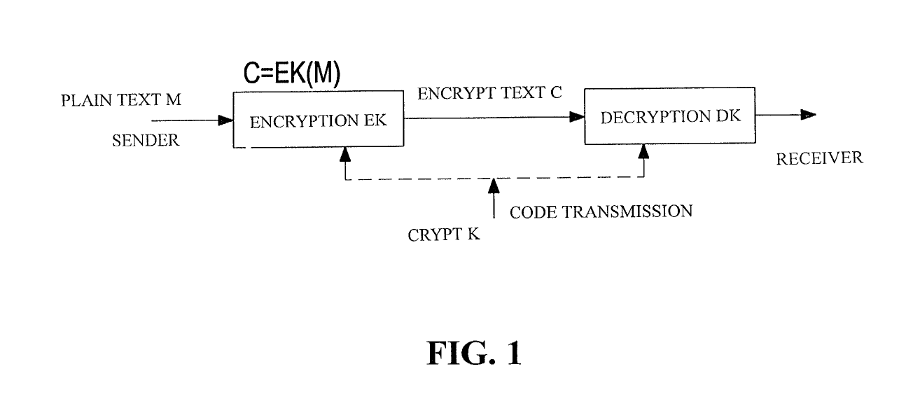

FIG. 2 is a flow chart to perform how to use cryptography with biometric verification on security authentication.

FIG. 3 is a flow chart to illustrate the process of biometric verification.

### DETAILED DESCRIPTION OF THE PREFERRED EMBODIMENT

Illustration of the following serial numbers:

1. Using the DES algorithm to generate a crypt key K1

2. The user's biometric characteristics

3. KDC

4. The crypt key K1 and biometric features of the user are decrypted by using the private key of KDC.

5. Verification

6. The KDC rejects to release the user's private key K2 using RSA.

7. The KDC allows releasing K2 by using RSA.

8. The user's host

9. K2 is decoded by using K1.

10. Biometric feature template input

11. Biometric feature extraction

12. Collation

This invention represents a method of using cryptography with biometric verification on security authentication. The method is used to security authentication by utilizing live biometric feature, which is non-transferable and unique among all humans, and operating the asymmetric key of cryptography technique for collation. The method provides cryptography technology in conjunction with the biometric authorization to ensure the encrypted data will not be broke or accessed by unauthorized persons when the information is transmitted from KDC. Furthermore, the object of the present invention is to store the user's PIN and biometric features on KDC and the user's PIN can be retrieved from KDC by performing the biometric verification. The mechanism can provide a high level assurance of secure transmission and prevent to carry multiple keys. All these elements will be described in more details below that the secret key is preferably generated using DES and the private key is preferably generated using RSA.

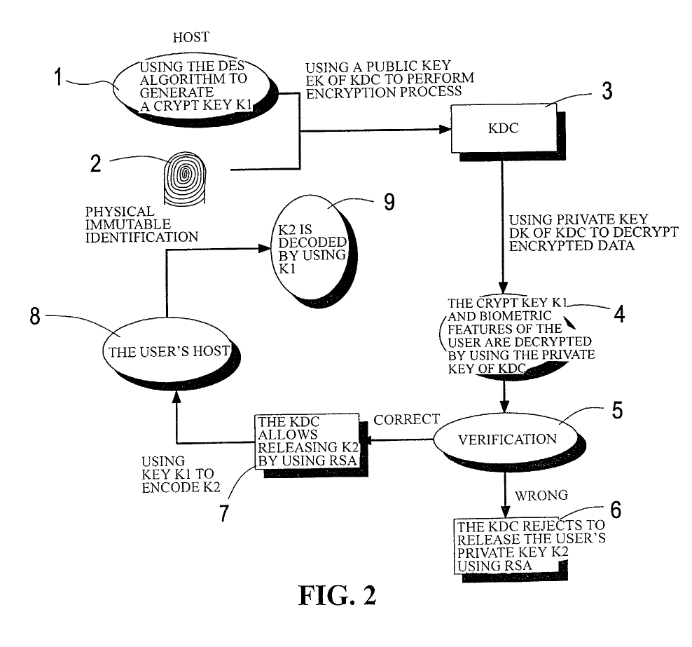

Referring now to FIG. 2, an illustrative embodiment of this invention is shown. The user connects to the host and a crypt key of the user K1 is generated by using the DES algoritm1. The present invention also provides the biometric authorization apparatus, which comprises an input device and a biometric sensor device for capturing both of personal information (PIN) and live physical immutable identification credentials of a user2. The encryption process is performed by using a public key EK of KDC and then the encrypted data which comprises the crypt key K1, biometric features and personal information of the user is to be transmitted to KDC3 via Internet. After receiving the encrypted data from the user's terminal, KDC can decrypt the encrypted data using its private key DK and proceed with the verification process. The verification process5 is performed by collating digitized BIR and activated biometric features4. Also, comparing the original stored numbers on the host with the decrypted key KI performs the verification. If the verification is not approved, KDC rejects to release the user's private key K2 using the RSA6. On the contrary, if the verification is successful, KDC allows releasing K2 by using RSA7 and then encodes K2 using K1 to transmit to the user's host8. After receiving the encrypted K2, the user can decode K2 using K19. Therefore, the method can overcome the need to carry, store, or remember private keys for encryption/decryption because the user's private keys can be retrieved from KDC by performing verification. The method also can prevent that using a single key only to perform authorization will reveal the privacy. This invention can be utilized in the application of the personal identification for providing business transactions and economic activities with high security standard over the Net.

The storage device of the user's host (terminal) can be a bank card, a credit card, a storage valued card, a magnetic strip card, an IC card, a smart card, an optical card, CD, DVD, a 2D bar code card, portable magnetic storage device, portable electronic memory device and portable mobile storage device. The user's private key K2 can be stored in a computer chip (for example, RAM, FLASH, EPROM, EEPROM) of the user's host. Therefore, the processor can perform the BIR process and encryption/decryption processes of the user's keys, which relates to calculation, collation and verification as a secured mechanism in the host. The method can ensure the user's private key K2 will not be broke or accessed by unauthorized persons when the information is transmitted from KDC.

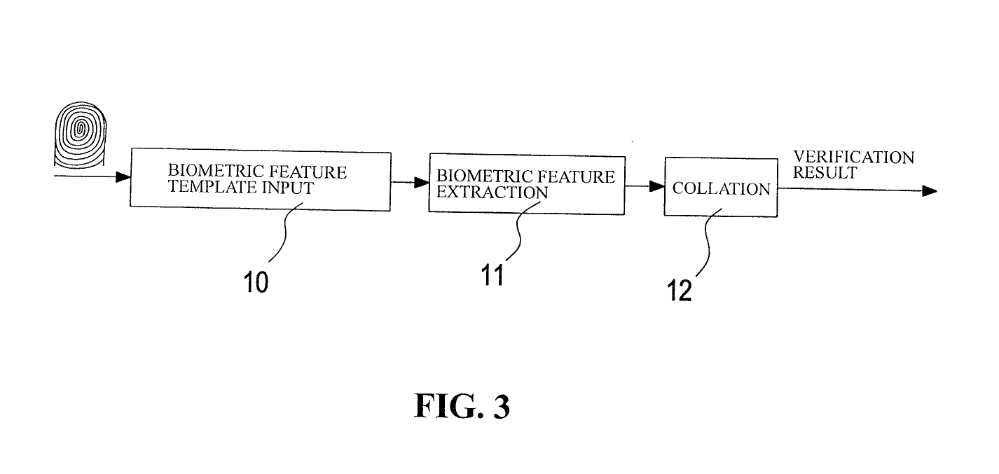

As seen in FIG. 3, collating the activated biometric features, which are input by the biometric sensor, and the enrollment biometric features template, which is extracted by algorithm from the biometric characteristics database, performs the biometric verification.

According to the standard of International Biometric Industry Association, the non-transferable unique biometric characteristics include fingerprint, voiceprint, face, iris, retina, palm print, palm shape, signature and other individual biometric characteristics. The Biometric Identification Record comprises raw data, processed data, signed data, encrypted data and feature points, which are extracted by algorithm.

In conclusion, the present invention has the following advantages:

1. This invention can overcome the problem, which the use of cryptographic keys for encryption/decryption, cannot perform authentication with high security.

2. The method can prevent that utilizing biometric features only to perform authentication will reveal privacy.

3. The present invention can provide high security of personal information.

4. Each person has his own unique feature among all humans; therefore, the user can do business transactions and economic activities with high security standards.

5. Utilizing the cryptography technology in conjunction with biometric authorization prevents that biometric features or confidential information will be forged or stole by third parties.

6. The method can overcome the need of carry, store, or remember private keys for encryption/decryption.

7. The invention can be utilized in the application of personal identification.

8. The present invention can be utilized in the application of business and industry.

1. A method of using cryptography with biometric verification on security authentication, comprising the steps of:
Utilizing physical immutable identification credentials of a user to perform authentication in conjunction with cryptography technology, and means for providing high security of transmission;
Generating a cryptographic key of the user using the DES algorithm from a user's host;
Encrypting means for using a public key of KDC to encrypt data including said cryptographic key and activated biometric features;
Transmitting means for transmitting said encrypted data from said host to said KDC for decryption; wherein
Decrypting said encrypted data using a private key of KDC to perform verification by collation and comparison; wherein
Collation means for collating said activated biometric features and digitized BIR stored on said KDC;
Comparison means for comparing said decrypted key with the original stored numbers on said KDC;
Approval means for getting approved from said verification, and for releasing the user's private key from said KDC;
Encoding said private key using said cryptographic key for transmitting to say host;
Retrieving said private key from said KDC, and for decoding said private key using said cryptographic key; and
Overcoming the need to carry, store or remember private keys for encryption/decryption.

2. The method of claim 1 wherein said user's host means for comprising a bank card, a credit card, a storage valued card, a magnetic strip card, an IC card, a smart card, an optical card, CD, DVD, a 2D bar code card, portable magnetic storage device, portable electronic memory device and portable mobile storage device.

3. The method of using cryptography with biometric verification on security authentication as defined in claim 1, and further comprising:
Storing said private key of the user in a computer chip; and
Performing the BIR process and encryption/decryption processes of the user by the processor, which relates to calculation, collation and verification as a secured mechanism in the host.

4. The method of claim 3 wherein said computer chip means for comprising RISC CPU, CISC CPU, DSP, FPGA, CPLD, NET ASIC, Microprocessor, Micro controller and other chips with function calculation; and wherein the elements of said chips means for comprising system-on-a-chip (SOC), system-on-multiple-integrated-chips and system-on-multiple-chips.

5. The method of claim 1 wherein said biometric characteristics means for comprising fingerprint, voiceprint, face, iris, retina, palm print, palm shape, signature and other individual biometric characteristics according to the standard of International Biometric Industry Association (IBIA).
